(19) United States
(12) Patent Application Publication
(10) Pub. No.: US 2026/0331846 A1
(43) Pub. Date: Oct. 22, 2026

(54) SHIELDED CABLE AND CONNECTOR

(71) Applicant: SUMITOMO WIRING SYSTEMS, LTD., Mie (JP)

(72) Inventors: Takahiro HASEGAWA, Mie (JP); Yutaka KOBAYASHI, Mie (JP)

(21) Appl. No.: 19/119,409

(22) PCT Filed: Oct. 17, 2023
(86) PCT No.: PCT/JP2023/037478

§ 371 Date: Apr. 9, 2025

(30) Foreign Application Priority Data
Oct. 18, 2022 (JP) 2022-166961

(51) Int. Cl. H01R 24/22; H01R 13/11; H01R 13/405; H01R 13/6582; H01R 13/6592

(52) U.S. Cl. CPC H01R 24/22; H01R 13/111; H01R 13/405; H01R 13/6582; H01R 13/6592

(57) ABSTRACT

A shielded cable includes a shield member for shielding noise on an outer peripheral surface of a cable member to be electrically connected to a mating connector via an electrical terminal. The shielded cable includes a tubular shield. The shield includes a wire crimping portion to be fixed to the shield member by crimping and a shield connecting portion for contacting a GND terminal of the mating connector when the electrical terminal is electrically connected to the mating connector. The wire crimping portion includes a collapsible protrusion for suppressing deformation of the shield connecting portion when the wire crimping portion is crimped to the shield member.

### TECHNICAL FIELD

The present disclosure relates to a shielded cable and a connector.

### BACKGROUND

Conventionally, a shielded cable in which a hollow cylindrical metal shell is electrically connected to a wire braid is known as disclosed in Patent Document 1. The braid is exposed from a sheath covering an insulated core wire and that exposed part is folded. The metal shell is fixed to the braid by being crimped to the folded part of the braid.

### PRIOR ART DOCUMENT

### Patent Document

Patent Document 1: JP H08-250218 A

### SUMMARY OF THE INVENTION

### Problems to be Solved

When the shielded cable is attached to a connection destination, the tip of the metal shell on a side opposite to the part crimped to the braid is electrically connected to a GND terminal of the connection destination. When the metal shell is crimped and fixed to the braid, a crimp stress is transmitted to the tip side of the metal shell, whereby the tip of the metal shell is expanded radially outward, resulting in a possibility of being deformed into a conical shape. In this case, since a diameter of the tip of the metal shell is not that of an aimed shape, a connected state of the tip of the metal shell and the connection destination of the shielded cable may be hindered.

The present disclosure aims to provide a shielded cable and a connector enabling a shield to be satisfactorily connected to a mating connector.

### Means to Solve the Problem

A shielded cable solving the above problem is provided with a shield member for shielding noise on an outer peripheral surface of a cable member to be electrically connected to a mating connector via an electrical terminal, and a tubular shield including a wire crimping portion to be fixed to the shield member by crimping and a shield connecting portion for contacting a GND terminal of the mating connector when the electrical terminal is electrically connected to the mating connector, the wire crimping portion including a collapsible protrusion for suppressing deformation of the shield connecting portion when the wire crimping portion is crimped to the shield member.

A connector solving the above problem is provided with a shielded cable provided with a shield member for shielding noise on an outer peripheral surface of a cable member to be electrically connected to a mating connector via an electrical terminal, a connector housing to be attached to a connection destination of the shielded cable and a cap for covering the electrical terminal, the shielded cable including a tubular shield having a wire crimping portion to be fixed to the shield member by crimping and a shield connecting portion for contacting a GND terminal of the mating connector when the electrical terminal is electrically connected to the mating connector, and the wire crimping portion including a collapsible protrusion for suppressing deformation of the shield connecting portion when the wire crimping portion is crimped to the shield member.

### Effect of the Invention

According to the present disclosure, a shield can be satisfactorily connected to a mating connector.

### BRIEF DESCRIPTION OF THE DRAWINGS

FIG. 1 is a perspective view of a connector of one embodiment.

FIG. 2 is a schematic diagram showing a mating connector to be connected to the connector.

FIG. 3 is an exploded perspective view of an assembled cable.

FIG. 4 is an exploded perspective view of the connector.

FIG. 5 is a section along V-V in FIG. 1.

FIG. 6 is a side view of a shield.

FIG. 7 is a back view of the shield.

FIG. 8 is a section along VIII-VIII in FIG. 1.

FIG. 9 is a perspective view of a cap when viewed from behind.

FIG. 10 is a side view in section showing a shielded cable before the shield is crimped.

FIG. 11 is a transverse section showing the shielded cable before the shield is crimped.

FIG. 12 is an enlarged side view in section showing the shape of a wire crimping portion after crimping.

### DETAILED DESCRIPTION TO EXECUTE THE INVENTION

First, embodiments of the present disclosure are listed and described.
[1] The shielded cable of the present disclosure is provided with a shield member for shielding noise on an outer peripheral surface of a cable member to be electrically connected to a mating connector via an electrical terminal, and a tubular shield including a wire crimping portion to be fixed to the shield member by crimping and a shield connecting portion for contacting a GND terminal of the mating connector when the electrical terminal is electrically connected to the mating connector, the wire crimping portion including a collapsible protrusion for suppressing deformation of the shield connecting portion when the wire crimping portion is crimped to the shield member.

According to the configuration of this example, unnecessary deformation of the shield by a crimping force can be allowed to escape by the deformation of the collapsible protrusion when the wire crimping portion of the shield is crimped to the shield member of the shielded cable. That is, when the wire crimping portion is crimped, the collapsible protrusion itself is crimped and deformed, thereby making it possible to hardly transfer the deformation to other parts of the shield. In this way, the shield connecting portion of the shield is hardly deformed. Thus, in the shield, the shape of the shield connecting portion to be connected to the GND terminal of the mating connector can be maintained in an optimal shape. Therefore, the shield can be satisfactorily connected to the mating connector.
[2] In [1] described above, the collapsible protrusion is one of a plurality of collapsible protrusions, and the plurality of collapsible protrusions are respectively provided at positions different in a circumferential direction of the shield. According to this configuration, the shield can be deformed in a well-balanced manner when the shield is crimped. This contributes to suppressing the deformation of the shield connecting portion.
[3] In [1] or [2] described above, the shield has a first region, the first region being a specified range in a circumferential direction of the shield, and a second region facing the first region in a diametrical direction of the shield, the collapsible protrusion is one of a plurality of collapsible protrusions, and the plurality of collapsible protrusions are arranged in each of the first region and the second region. According to this configuration, if the collapsible protrusions in the first region are collapsed by a center of one die and the collapsible protrusions in the second region are collapsed by a center of the other die, for example, when the collapsible protrusions are crimped by sandwiching the shield by the vertically divided dies, the collapsible protrusions are not collapsed at positions where collapse loads of the dies are hardly applied. Thus, it can be made difficult to leave the collapsible protrusions in an insufficiently collapsed state.
[4] In any one of [1] to [3] described above, the collapsible protrusion is formed into a shape raised from the wire crimping portion to have a space inside before being deformed. According to this configuration, since the collapsible protrusion can be shaped to be easily collapsible, crimping workability can be improved.
[5] In any one of [1] to [4] described above, the shield connecting portion includes a leaf spring portion for contacting the GND terminal on an outer peripheral surface of the shield. According to this configuration, even if the shield is fixed to the shield member by crimping, the position of the leaf spring portion is hardly affected. Thus, the leaf spring portion can be brought into contact with the GND terminal with an optimal tension. This further contributes to satisfactorily connecting the shield to the mating connector.
[6] In any one of [1] to [5] described above, the shield member includes a folded portion formed by folding an end part of the shield member, and the wire crimping portion is crimped to the folded portion. According to this configuration, the shield can be fixed by being crimped to the folded portion of the shield member where crimping is easily performed.
[7] In [6] described above, the shielded cable is provided with a ring member for sandwiching and holding the folded portion together with the wire crimping portion inside the folded portion. According to this configuration, the shield can be tightly fixed to the shield member, using the ring member as a seat.
[8] In any one of [1] to [7] described above, the shield includes an engaging portion to be engaged with a connector housing so that the shield does not come out from the connector housing when the shield is mounted into the connector housing to be connected to the mating connector. According to this configuration, since the shield can be held in the connector housing by the engaging portion, it can be made difficult to detach the shield from the connector housing.
[9] In any one of [1] to [8] described above, the shield includes a positioning portion for positioning the shield in an insertion direction into a connector housing when the shield is mounted into the connector housing to be connected to the mating connector. According to this configuration, since the shield can be positioned in the insertion direction with respect to the connector housing, the shield can be arranged at an optimal mounted position.
[10] In any one of [1] to [9] described above, the electrical terminal includes a terminal body to be connected to a mating connector terminal of the mating connector and a terminal end portion fixed to the cable member, the terminal body is exposed to outside the shield, and the terminal end portion is accommodated inside the shield. According to this configuration, the shield can be formed into a short shape to cover only the periphery of an end part of the electrical terminal.
[11] The connector of the present disclosure is provided with a shielded cable provided with a shield member for shielding noise on an outer peripheral surface of a cable member to be electrically connected to a mating connector via an electrical terminal, a connector housing to be attached to a connection destination of the shielded cable and a cap for covering the electrical terminal, the shielded cable including a tubular shield having a wire crimping portion to be fixed to the shield member by crimping and a shield connecting portion for contacting a GND terminal of the mating connector when the electrical terminal is electrically connected to the mating connector, and the wire crimping portion including a collapsible protrusion for suppressing deformation of the shield connecting portion when the wire crimping portion is crimped to the shield member. According to this configuration, functions and effects similar to those of the shielded cable are obtained.

### DETAILS OF EMBODIMENT OF PRESENT DISCLOSURE

A specific example of the present disclosure is described with reference to the drawings. Note that the present invention is not limited to these illustrations, but is represented by claims and intended to include all changes in the scope of claims and in the meaning and scope of equivalents. For the convenience of description, some components may be shown in an exaggerated or simplified manner in each drawing. Further, a dimension ratio of each part may be different from an actual one.

### Wiring Harness 1

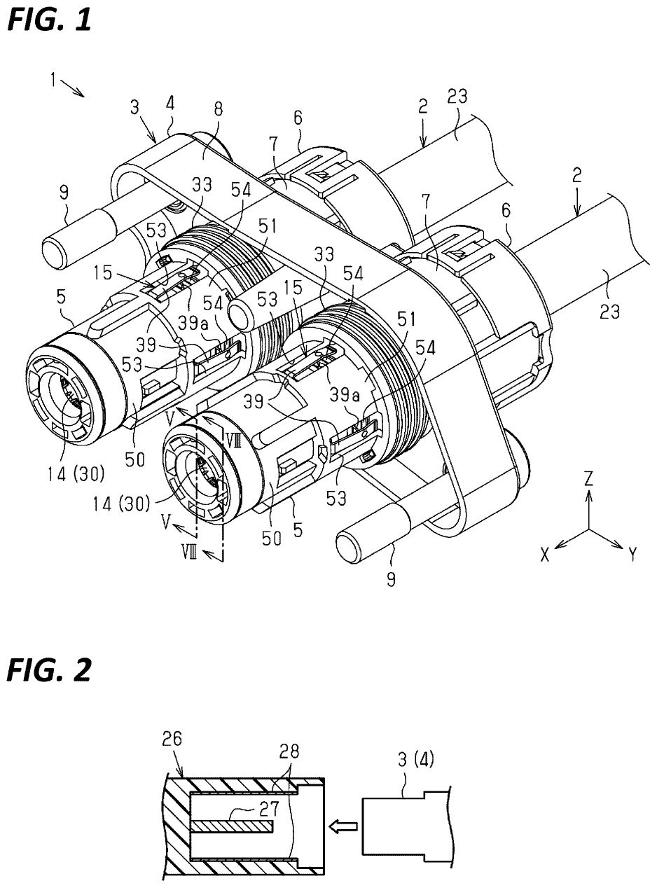

As shown in FIG. 1, a wiring harness 1 is provided with shielded cables 2 and a connector 3 for attaching the shielded cables 2 to a connection destination. The connector 3 is provided with a connector housing 4, caps 5 attached to the tips of the shielded cables 2 and covers 6 for covering the back surface of the connector housing 4. The connector housing 4 includes tube portions 7, into which the shielded cables 2 are inserted, and a plate-like portion 8 to be fixed to the connection destination. The plate-like portion 8 is fixed to the connection destination by a plurality of (two shown in FIG. 1) fasteners 9. The fasteners 9 are, for example, bolts.

In the case of this example, a plurality of the shielded cables 2 are provided side by side. A total of two shielded cables 2 are provided on a positive terminal side and a negative terminal side in this example. Note that since these shielded cables 2 have the same structure, only the shielded cable 2 on one side is described. The cap 5 and the cover 6 are provided for each shielded cable 2. The cap 5 is, for example, formed into a substantially hollow cylindrical shape. The cover 6 is so shaped that the shielded cable 2 is pulled out from the back surface of the tube portion 7 of the connector housing 4 while holding the shielded cable 2. The cover 6 is fixed to the connector housing 4, for example, by a locking structure.

### Shielded Cable 2

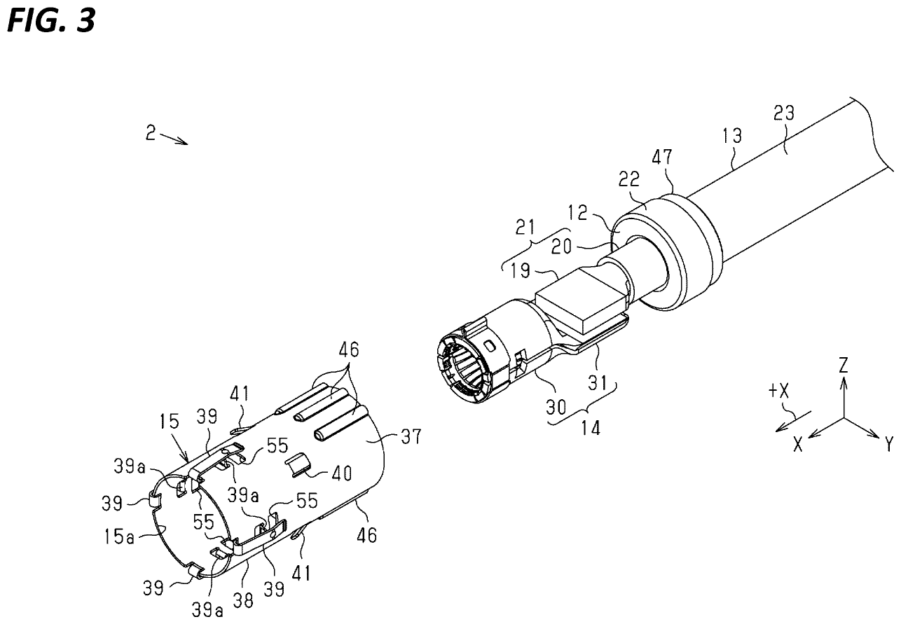

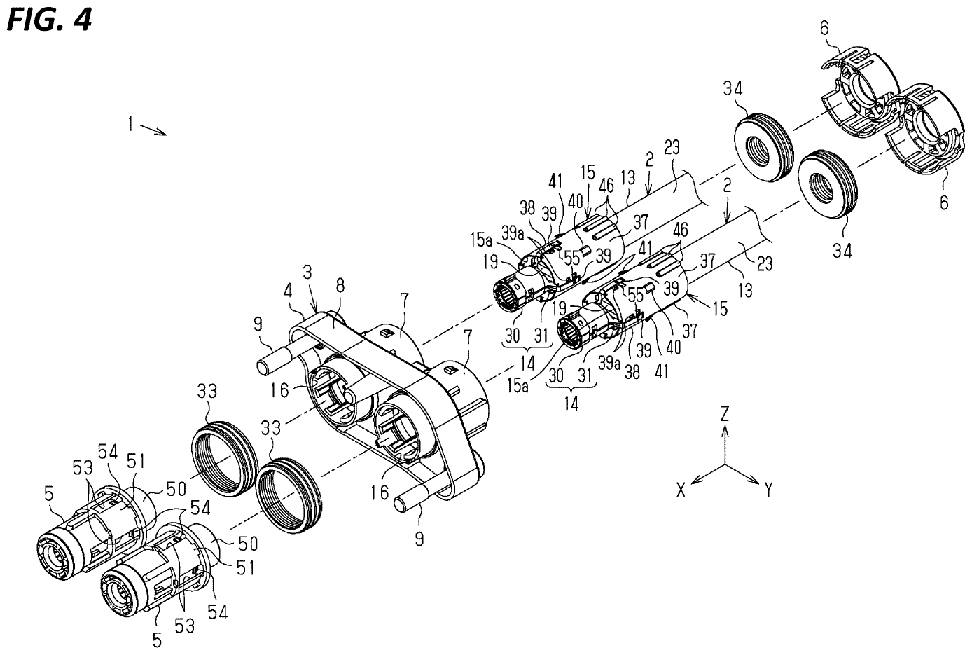

As shown in FIGS. 3 and 4, the shielded cable 2 is provided with a cable body 13 including a shield member 12 for shielding noise, an electrical terminal 14 mounted on the tip of the cable body 13 and a tubular shield 15 for connecting the shield member 12 to GND. The shielded cable 2 is mounted into the connector housing 4 by being inserted into a hole 16 (see FIG. 4) of the tube portion 7.

As shown in FIG. 3, the shielded cable 2 (cable body 13) is provided with a cable member 21 including a core wire 19 and an insulation coating 20. The cable member 21 includes, for example, the core wire 19 made of a conductor and the insulation coating 20 covering the outer periphery of the core wire 19. The cable member 21 is, for example, a high-voltage cable compatible with a high voltage and a large current.

The core wire 19 is, for example, a stranded wire formed by twisting a plurality of metal strands or a single-core wire constituted by one columnar metal bar having a solid internal structure. The core wire 19 may be a combination of a stranded wire and a plurality of types of conductors such as a single-core wire. A copper-based or aluminum-based metal material is, for example, used as a material of the core wire 19.

The insulation coating 20 covers, for example, the outer peripheral surface of the core wire 19 over an entire periphery. The insulation coating 20 is, for example, made of an insulating material such as synthetic resin. A synthetic resin mainly containing a polyolefin-based resin such as cross-linked polyethylene or cross-linked polypropylene is used as a material of the insulation coating 20. One type of material may be singly used or two or more types of materials may be used in appropriate combination as the material of the insulation coating 20.

The shield member 12 is, for example, a braid (braided wire) formed by bundling thin metal wires into a braid shape. The shield member 12 includes a folded portion 22 formed by folding the shield member 12 in an end part of the shield member 12. A covering member 23 for covering the cable member 21 from outside is provided on the outer peripheral surface of the shield member 12. The covering member 23 is, for example, a protective coating made of resin.

### Mating Connector 26

As shown in FIG. 2, the connector 3 (connector housing 4) is connected to a mating connector 26 as a connection destination of the wiring harness 1. The mating connector 26 is a female connector, for example, if the connector 3 is a male connector. The mating connector 26 includes mating connector terminals 27 to be connected to the electrical terminals 14. Grounded GND terminals 28 are provided inside the mating connector 26. The GND terminal 28 is, for example, a plate-like electrical contact point provided on the inner peripheral surface of the mating connector 26.

### Shape of Electrical Terminal 14

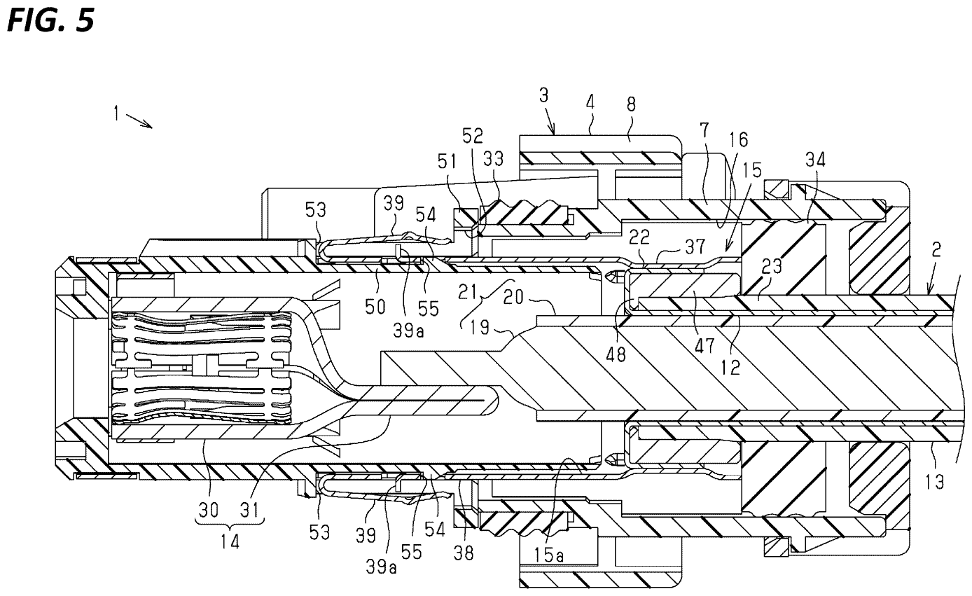

As shown in FIG. 5, the electrical terminal 14 includes a terminal body 30 to be connected to the mating connector terminal 27 of the mating connector 26 and a terminal end portion 31 fixed to the cable body 13. The terminal body 30 is exposed to outside the shield 15. The terminal end portion 31 is accommodated inside the shield 15. In the case of this example, the terminal body 30 is formed into a tubular shape and the terminal end portion 31 is formed into a flat plate shape in the electrical terminal 14. The electrical terminal 14 is accommodated into the cap 5 when the cap 5 is attached. In this way, the cap 5 covers the electrical terminal 14.

### Sealing Structure of Connector 3

As shown in FIGS. 4 and 5, a first sealing member 33 for sealing a gap between the connector housing 4 and the mating connector 26 is provided in the connector housing 4. The first sealing member 33 is, for example, a seal made of rubber. The first sealing member 33 is, for example, mounted on the outer periphery of a part of the tube portion 7, into which the cap 5 is inserted.

A second sealing member 34 is provided between the shielded cable 2 and the connector housing 4 to seal a gap between the shielded cable 2 and the connector housing 4. The second sealing member 34 is, for example, a seal made of rubber. The second sealing member 34 is, for example, arranged between the outer peripheral surface of the shielded cable 2 and the inner peripheral surface of the tube portion 7.

### Shield 15

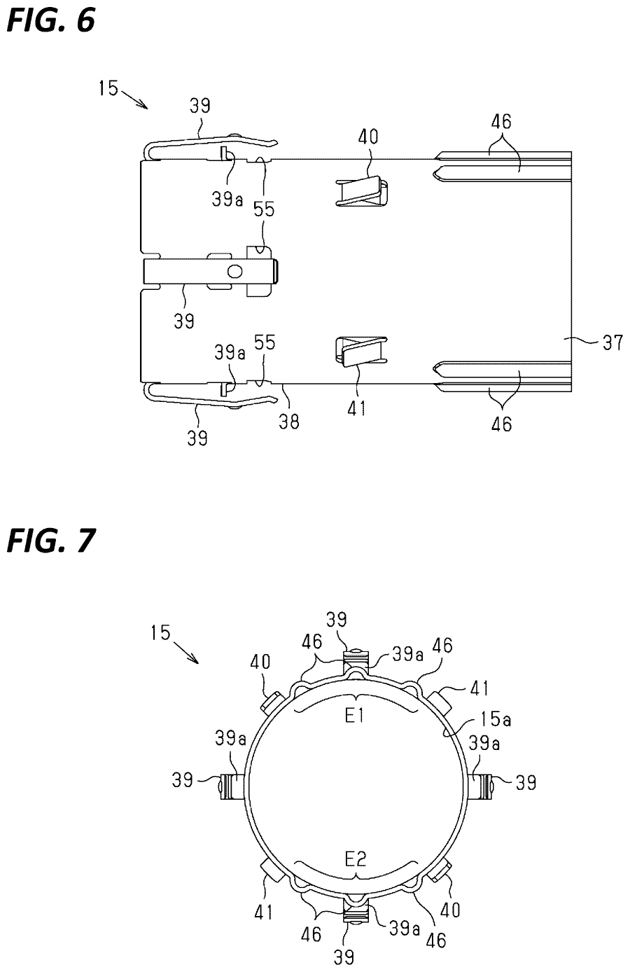

As shown in FIGS. 3 to 6, the shield 15 includes a wire crimping portion 37 to be fixed to the shield member 12 by crimping and a shield connecting portion 38 for contacting the GND terminal 28 of the mating connector 26 when the electrical terminal 14 is electrically connected to the mating connector 26. The shield 15 is, for example, formed into a substantially hollow cylindrical shape and includes a hole 15a, through which the tip of the cable body 13 and the electrical terminal 14 are passed.

The shield connecting portion 38 includes leaf spring portions 39 for contacting the GND terminal 28 on the outer peripheral surface of the shield 15. A plurality of the leaf spring portions 39 are provided and arranged at equal intervals in a circumferential direction of the shield 15. The leaf spring portion 39 is, for example, formed into a cantilever shape and includes a contact point in the form of a circular protrusion for contacting the GND terminal 28. The shield 15 is formed with projections 39a capable of contacting the back surfaces of the leaf spring portions 39. The projection 39a is formed by cutting a part of the shield 15 and bending the cut part.

The shield 15 includes engaging portions 40 to be engaged with the connector housing 4 so that the shield 15 does not come out from the connector housing 4 when the shield 15 is mounted into the connector housing 4 to be connected to the mating connector 26. A plurality of (two in this example) the engaging portions 40 are provided on the outer peripheral surface of the shield 15. A pair of the engaging portions 40 are arranged to face each other in a diametrical direction of the shield 15. The engaging portion 40 is, for example, formed into a projection shape having a slope descending with respect to an insertion direction (+X axis direction shown in FIG. 3) of the shield 15 into the connector housing 4.

The shield 15 includes positioning portions 41 for positioning the shield 15 in the insertion direction (+X axis direction shown in FIG. 3) into the connector housing 4 when the shield 15 is mounted into the connector housing 4 to be connected to the mating connector 26. A plurality of (two in this example) the positioning portions 41 are provided on the outer peripheral surface of the shield 15. A pair of the positioning portions 41 are arranged to face each other in a diametrical direction of the shield 15. The positioning portion 41 is, for example, formed into a projection shape having a slope ascending with respect to the insertion direction (+X axis direction shown in FIG. 3) of the shield 15 into the connector housing 4.

As shown in FIG. 7, the plurality of leaf spring portions 39 are arranged at angles of 90° in the circumferential direction of the shield 15. The engaging portion 40 is arranged at a position separated by 45° in the circumferential direction of the shield 15 from the leaf spring portions 39 adjacently located in the circumferential direction. The positioning portion 41 is arranged at a position separated by 45° in the circumferential direction of the shield 15 from the leaf spring portions 39 adjacently located in the circumferential direction. The engaging portions 40 and the positioning portions 41 are alternately arranged at angles of 90° in the circumferential direction of the shield 15.

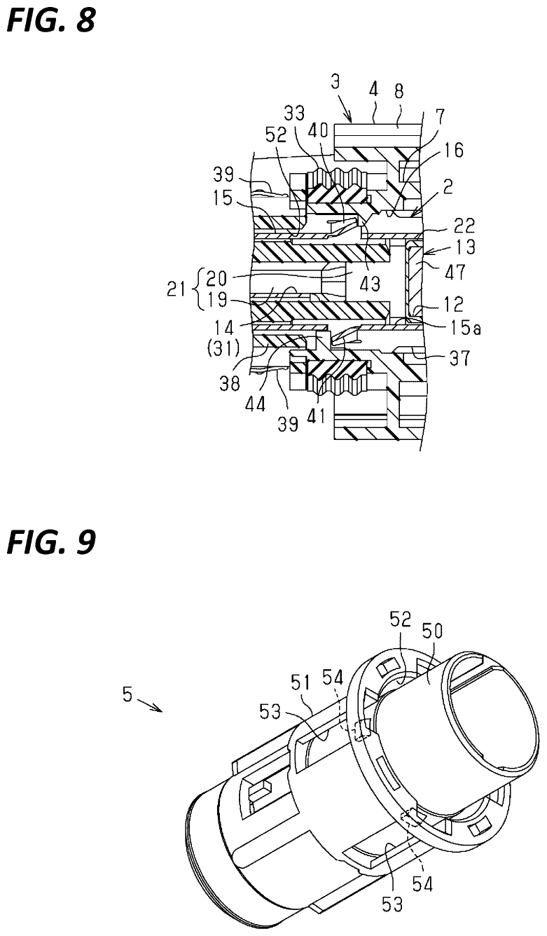

As shown in FIG. 8, the connector housing 4 is formed with protrusions 43 to be engaged with the engaging portions 40 of the shield 15. The protrusions 43 are, for example, formed on the inner peripheral surface of the hole 16 of the tube portion 7. By the engagement of the engaging portions 40 with the protrusions 43, the shield 15 is prevented from coming out from the connector housing 4. The connector housing 4 is formed with protrusions 44 to be engaged with the positioning portions 41 of the shield 15. The protrusions 44 are, for example, formed on the inner peripheral surface of the hole 16 of the tube portion 7. By the contact of the positioning portions 41 with the protrusions 44, a position when the shield 15 is inserted into the connector housing 4 is set.

### Crimping Structure Using Collapsible Protrusions 46

As shown in FIGS. 3 to 7, the wire crimping portion 37 includes a plurality of collapsible protrusions 46 for suppressing the deformation of the shield connecting portion 38 when the wire crimping portion 37 is crimped to the shield member 12. In the case of this example, the shield 15 is fixed to the shield member 12, such as by crimping the wire crimping portion 37 (including the collapsible protrusions 46) to the shield member 12. The collapsible protrusions 46 are deformed and mounted on the shield member 12 at the time of crimping. The collapsible protrusions 46 are formed at a plurality of positions different in the circumferential direction of the shield 15. The wire crimping portion 37 is crimped to the folded portion 22.

As shown in FIG. 7, the shield 15 has a first region E1, which is a specified range in the circumferential direction in the shield 15, and a second region E2 facing the first region E1 in a diametrical direction of the shield 15. The first region E1 is a part near a top part of the shield 15 (near 0 o'clock in a clock) when the shield 15 is viewed from an axial direction. The second region E2 is a part near a bottom part of the shield 15 (near 6 o'clock in the clock) when the shield 15 is viewed from the axial direction. A plurality of (three in this example) the collapsible protrusions 46 are arranged in each of the first and second regions E1, E2. The collapsible protrusion 46 is formed into a shape raised from the wire crimping portion 37 to have a space inside before being deformed.

As shown in FIGS. 3 and 5, the shielded cable 2 is provided with a ring member 47 serving as a seat when the shield 15 is crimped to the shield member 12. The ring member 47 is, for example, made of metal. A flange 48 (shown in FIG. 5) to be hooked to an end part of the covering member 23 is formed on the base end of the ring member 47. The ring member 47 is arranged inside the folded portion 22 on the outer peripheral surface of the covering member 23 of the shield member 12 and sandwiches and holds the folded portion 22 together with the wire crimping portion 37.

### Functions of Cap 5

As shown in FIG. 9, the cap 5 includes a cap body 50 for accommodating the electrical terminal 14 of the shielded cable 2 and an outer peripheral wall 51 arranged while being spaced apart from the cap body 50 by a predetermined distance. The cap body 50 is, for example, formed into a hollow cylindrical shape. The outer peripheral wall 51 is circumferentially formed around the cap body 50. The shield 15 is inserted into a gap 52 between the cap body 50 and the outer peripheral wall 51 when being mounted into the connector housing 4.

As shown in FIG. 5, the outer peripheral wall 51 of the cap 5 is formed with holes 53 for exposing the leaf spring portions 39 of the mounted shield 15 to outside. Projections 54 to be engaged with the shield 15 are formed on the outer peripheral surface of the cap body 50. The shield 15 is formed with recesses 55 to be engaged with the projections 54. The recesses 55 are, for example, through holes. The cap body 50 is arranged between the electrical terminal 14 and the shield 15 when the cap 5 is attached to the shield 15, thereby insulating the electrical terminal 14 and the shield 15.

### Functions of Embodiment

Next, functions of the connector 3 of this embodiment are described.

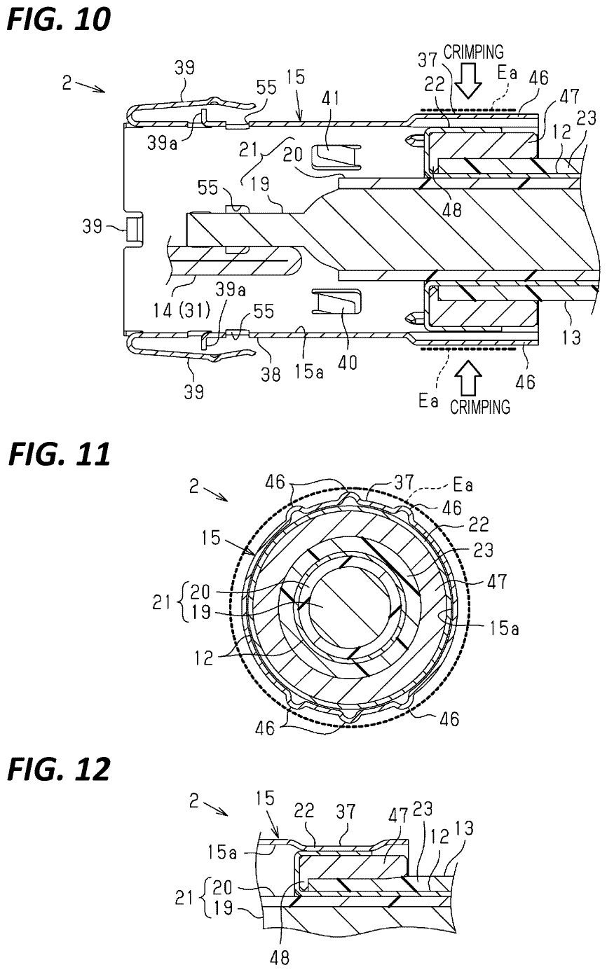

As shown in FIGS. 10 and 11, the shield 15 is first fixed to the cable body 13 by crimping. In the case of this example, the wire crimping portion 37 is crimped by sandwiching and crimping the periphery (crimping region Ea indicated by a dotted line in FIGS. 10 and 11) of the wire crimping portion 37 (including the collapsible protrusions 46) by a die. Crimping using a press die is, for example, used to crimp the wire crimping portion 37.

In the case of using press working, the wire crimping portion 37 is, for example, sandwiched by a pair of dies having arcuate pressing surfaces. At this time, the collapsible protrusions 46 in the first region E1 are collapsed by one die and the collapsible protrusions 46 in the second region E2 are collapsed by the other die. The collapsible protrusions 46 in the first and second regions E1, E2 are pressed and collapsed by die centers (arcuate surface centers) where a press pressure is high. Thus, these collapsible protrusions 46 can be firmly collapsed and deformed at high loads.

If the wire crimping portion 37 is crimped as shown in FIG. 12, the wire crimping portion 37 is concavely deformed by being crimped by that crimping force. At this time, unnecessary deformation of the shield 15 by the crimping force is allowed to escape by the collapse of the collapsible protrusions 46. In this way, when the wire crimping portion 37 is crimped, the collapsible protrusions 46 themselves are crimped and deformed, thereby making it possible to hardly transfer the deformation to other parts of the shield 15. In this way, the shield connecting portion 38 of the shield 15 is hardly deformed. Thus, the shape of the shield connecting portion 38 can be maintained in an optimal shape. Therefore, the shield 15 can be satisfactorily connected to the mating connector 26.

After the shielded cable 2 is fabricated by mounting the shield 15 on the cable body 13, this shielded cable 2 is mounted into the connector housing 4. Specifically, the shielded cable 2 is inserted into the hole 16 of the connector housing 4. The shielded cable 2 is inserted until the positioning portions 41 contact the protrusions 44 of the connector housing 4. Further, when the shielded cable 2 is inserted to the back of the hole 16, the engaging portions 40 are hooked to the protrusions 43 to be retained. In this way, the shield 15, i.e. the shielded cable 2, is fixed to the connector housing 4.

Subsequently, the cap 5 is attached to the shielded cable 2 mounted into the connector housing 4. At this time, the cap 5 is attached to the shielded cable 2 to insert the shield 15 into the gap 52. The shield 15 is inserted until the projections 54 of the cap 5 are engaged with the recesses 55 of the shield 15 while the leaf spring portions 39 of the shield 15 are located in the holes 53 of the cap 5. In the above way, the connector 3 is assembled.

### Effects of Embodiment

According to the connector 3 of this embodiment, the following effects can be achieved.
(1) The shielded cable 2 is provided with the shield member 12 for shielding noise on the outer peripheral surface of the cable member 21 to be electrically connected to the mating connector 26 via the electrical terminal 14. The shielded cable 2 is provided with the tubular shield 15. The shield 15 includes the wire crimping portion 37 to be fixed to the shield member 12 by crimping and the shield connecting portion 38 for contacting the GND terminal 28 of the mating connector 26 when the electrical terminal 14 is electrically connected to the mating connector 26. The wire crimping portion 37 includes the collapsible protrusions 46 for suppressing the deformation of the shield connecting portion 38 when the wire crimping portion 37 is crimped to the shield member 12.

According to the configuration of this example, when the wire crimping portion 37 of the shield 15 is crimped to the shield member 12 of the shielded cable 2, unnecessary deformation of the shield 15 by a crimping force can be allowed to escape by the deformation of the collapsible protrusions 46. That is, when the wire crimping portion 37 is crimped, the collapsible protrusions 46 themselves are crimped and deformed, thereby making it possible to hardly transfer the deformation to other parts of the shield 15. In this way, the shield connecting portion 38 of the shield 15 is hardly deformed. Thus, in the shield 15, the shape of the shield connecting portion 38 to be connected to the GND terminal 28 of the mating connector 26 can be maintained in an optimal shape. Therefore, the shield 15 can be satisfactorily connected to the mating connector 26.
(2) The plurality of collapsible protrusions 46 are respectively formed at the positions different in the circumferential direction of the shield 15. According to this configuration, the shield 15 can be deformed in a well-balanced manner when being crimped. This contributes to suppressing the deformation of the shield connecting portion 38.
(3) The shield 15 has the first region E1, which is a specified range in the circumferential direction in the shield 15, and the second region E2 facing the first region E1 in the diametrical direction of the shield 15. The plurality of collapsible protrusions 46 are arranged in each of the first and second regions E1, E2. According to this configuration, if the collapsible protrusions 46 in the first region E1 are collapsed by the center of one die and the collapsible protrusions 46 in the second region E2 are collapsed by the center of the other die, for example, when the collapsible protrusions 46 are crimped by sandwiching the shield 15 by the vertically divided dies, the collapsible protrusions 46 are not collapsed at positions where collapse loads of the dies are hardly applied. Thus, it can be made difficult to leave the collapsible protrusions 46 in an insufficiently collapsed state.
(4) The collapsible protrusion 46 is formed into the shape raised from the wire crimping portion 37 to have the space inside before being deformed. According to this configuration, since the collapsible protrusion 46 can be shaped to be easily collapsible, crimping workability can be improved.
(5) The shield connecting portion 38 includes the leaf spring portions 39 for contacting the GND terminal 28 on the outer peripheral surface of the shield 15. According to this configuration, even if the shield 15 is fixed to the shield member 12 by crimping, the positions of the leaf spring portions 39 are hardly affected. Thus, the leaf spring portions 39 can be brought into contact with the GND terminal 28 with an optimal tension. This further contributes to satisfactorily connecting the shield 15 to the mating connector 26.
(6) The shield member 12 includes the folded portion 22 formed by folding the end part of the shield member 12. The wire crimping portion 37 of the shield 15 is crimped to the folded portion 22 of the shield member 12. According to this configuration, the shield 15 can be crimped and fixed to the folded portion 22 of the shield member 12 where crimping is easily performed.
(7) The shielded cable 2 is provided with the ring member 47 arranged inside the folded portion 22. The ring member 47 sandwiches and holds the folded portion 22 together with the wire crimping portion 37. According to this configuration, the shield 15 can be tightly fixed to the shield member 12, using the ring member 47 as a seat.
(8) The shield 15 includes the engaging portions 40 to be engaged with the connector housing 4 so that the shield 15 does not come out from the connector housing 4 when the shield 15 is mounted into the connector housing 4 to be connected to the mating connector 26. According to this configuration, since the shield 15 can be held in the connector housing 4 by the engaging portions 40, the shield 15 can be made difficult to detach from the connector housing 4.
(9) The shield 15 includes the positioning portions 41 for positioning the shield 15 in the insertion direction into the connector housing 4 when the shield 15 is mounted into the connector housing 4 to be connected to the mating connector 26. According to this configuration, since the shield 15 can be positioned in the insertion direction with respect to the connector housing 4, the shield 15 can be arranged at an optimal mounting position.
(10) The electrical terminal 14 includes the terminal body 30 to be connected to the mating connector terminal 27 of the mating connector 26 and the terminal end portion 31 fixed to the cable member 21. The terminal body 30 is exposed to outside the shield 15. The terminal end portion 31 is accommodated inside the shield 15. According to this configuration, the shield 15 can be formed into a short shape to cover only the periphery of an end part of the electrical terminal 14.

### Other Embodiments

Note that the above embodiment can be modified and carried out as follows. The above embodiment and the following modifications can be carried out in combination without technically contradicting each other.
The folded portion 22 may be omitted in the shielded cable 2, and the shield 15 may be crimped to an unfolded part of the shield member 12 exposed from the covering member 23 in the shielded cable 2.
The ring member 47 may be omitted from the shielded cable 2.
The shield member 12 is not limited to a braid and, for example, another member such as a pipe member (pipe shield) may be used.
The shape of the collapsible protrusion 46 when the shield 15 is viewed from a direction orthogonal to the axis is not limited to a linear shape. For example, the shape of the collapsible protrusion 46 when the shield 15 is viewed from the direction orthogonal to the axis may be changed to another shape such as a curved shape or a dotted shape.
The shape of the collapsible protrusion 46 when the shield 15 is viewed from the axial direction is not limited to a semicircular shape and may be, for example, changed to another shape such as a triangular shape or a trapezoidal shape.
The collapsible protrusions 46 are not limited to those formed only in parts of the outer peripheral surface of the shield 15 and may be, for example, formed on the entire outer peripheral surface in the circumferential direction.
The collapsible protrusion 46 may be configured by combining different protrusion shapes.
Only one collapsible protrusion 46 may be provided.
The electrical terminal 14 may be entirely located inside the shield 15.
The leaf spring portion 39 is not limited to a cantilevered spring and may be, for example, changed to another type of spring such as a disc spring or a spiral spring.
Only one leaf spring portion 39 may be provided.
The shapes of the engaging portions 40 and the positioning portions 41 can be changed to various shapes if the engaging portions 40 and the positioning portions 41 can be engaged with the connector 3 (connector housing 4). Further, the numbers and arranged positions of the engaging portions 40 and the positioning portions 41 are not limited to those in the embodiment and may be changed as appropriate.
The connector 3 is not limited to the one for vehicle and may be used in another device or apparatus.
The individual collapsible protrusions 46 of the shown embodiment may be referred to as radially-outward protrusions collapsible radially inward or U-shaped folds collapsible radially inward. In the shown embodiment, a group of the plurality of collapsible protrusions 46 arranged in each local region (first region E1 or second region E2) of the tubular shield 15 may be referred to as a subset of axially-elongated protrusions collapsible radially inward. The plurality of collapsible protrusions 46 arranged in each local region (first region E1 or second region E2) of the tubular shield 15 may be parallel to each other and may, for example, extend along the axis of the tubular shield 15.
In the shown embodiment, the shield 15 may be configured such that only the wire crimping portion 37 is plastically deformable in the shield 15 by the plurality of collapsible protrusions 46 when the wire crimping portion 37 is crimped.
As shown in FIG. 7, a thickness of the collapsible protrusion 46 of the wire crimping portion 37 in the diametrical direction may be equal to those of other parts of the wire crimping portion 37 in the diametrical direction.
As shown in FIG. 7, the plurality of collapsible protrusions 46 arranged in the same region (first region E1 or second region E2) may be separated at a constant or equal distance in the circumferential direction of the shield 15.
Although the present disclosure has been described with respect to the embodiment, the present disclosure is understood not to be limited to the embodiment and structures. The present disclosure also encompasses various modifications and modifications within the scope of equivalents. In addition, various combinations and forms, further other combinations and forms including only one element, more elements or less elements are also within the scope of the present disclosure and within the scope of thoughts.

### LIST OF REFERENCE NUMERALS

1 wiring harness
2 shielded cable
3 connector
4 connector housing
5 cap
6 cover
7 tube portion
8 plate-like portion
9 fastener
12 shield member
13 cable body
14 electrical terminal
15 shield
15a hole
16 hole
19 core wire
20 insulation coating
21 cable member
22 folded portion
23 covering member
26 mating connector
27 mating connector terminal
28 GND terminal
30 terminal body
31 terminal end portion
33 first sealing member
34 second sealing member
37 wire crimping portion
38 shield connecting portion
39 leaf spring portion
39a projection
40 engaging portion
41 positioning portion
43 protrusion
44 protrusion
46 collapsible protrusion
47 ring member
48 flange
50 cap body
51 outer peripheral wall
52 gap
53 hole
54 projection
55 recess
E1 first region
E2 second region

1. A shielded cable provided with a shield member for shielding noise on an outer peripheral surface of a cable member to be electrically connected to a mating connector via an electrical terminal, comprising:
a tubular shield including a wire crimping portion to be fixed to the shield member by crimping and a shield connecting portion for contacting a GND terminal of the mating connector when the electrical terminal is electrically connected to the mating connector,
the wire crimping portion including a collapsible protrusion for suppressing deformation of the shield connecting portion when the wire crimping portion is crimped to the shield member.

2 . The shielded cable according to claim 1, wherein:
the collapsible protrusion is one of a plurality of collapsible protrusions, and
the plurality of collapsible protrusions are respectively provided at positions different in a circumferential direction of the shield.

3. The shielded cable according to claim 1, wherein:
the shield has a first region, the first region being a specified range in a circumferential direction of the shield, and a second region facing the first region in a diametrical direction of the shield,
the collapsible protrusion is one of a plurality of collapsible protrusions, and
the plurality of collapsible protrusions are arranged in each of the first region and the

4. The shielded cable according to claim 1, wherein the collapsible protrusion is formed into a shape raised from the wire crimping portion to have a space inside before being deformed.

5. The shielded cable according to claim 1, wherein the shield connecting portion includes a leaf spring portion for contacting the GND terminal on an outer peripheral surface of the shield.

6. The shielded cable according to claim 1, wherein:
the shield member includes a folded portion formed by folding an end part of the shield member, and
the wire crimping portion is crimped to the folded portion.

7. The shielded cable according to claim 6, comprising a ring member for sandwiching and holding the folded portion together with the wire crimping portion by being arranged inside the folded portion.

8. The shielded cable according to claim 1, wherein the shield includes an engaging portion to be engaged with a connector housing so that the shield does not come out from the connector housing when the shield is mounted into the connector housing to be connected to the mating connector.

9. The shielded cable according to claim 1, wherein the shield includes a positioning portion for positioning the shield in an insertion direction into a connector housing when the shield is mounted into the connector housing to be connected to the mating connector.

10. The shielded cable according to claim 1, wherein:
the electrical terminal includes a terminal body to be connected to a mating connector terminal of the mating connector and a terminal end portion fixed to the cable member, the terminal body is exposed to outside the shield, and the terminal end portion is accommodated inside the shield.

11. A connector, comprising:
a shielded cable provided with a shield member for shielding noise on an outer peripheral surface of a cable member to be electrically connected to a mating connector via an electrical terminal;
a connector housing to be attached to a connection destination of the shielded cable; and
a cap for covering the electrical terminal,
the shielded cable including a tubular shield having a wire crimping portion to be fixed to the shield member by crimping and a shield connecting portion for contacting a GND terminal of the mating connector when the electrical terminal is electrically connected to the mating connector, and
the wire crimping portion including a collapsible protrusion for suppressing deformation of the shield connecting portion when the wire crimping portion is crimped to the shield member.
